(19) United States
(12) Patent Application Publication
(10) Pub. No.: US 2004/0112246 A1
(43) Pub. Date: Jun. 17, 2004

(54) Device for detachably interlinking two vehicles elements of a vehicle that are arranged in tandem, and the use thereof

(76) Inventors: Norbert Ralf Gain, Weil der Stadt (DE); Guido Kubler, Bobingen (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/296,239

(22) PCT Filed: May 31, 2001
(86) PCT No.: PCT/EP01/06201

(30) Foreign Application Priority Data
Jun. 7, 2000 (DE) 10028234.2

(51) Int. Cl. B60D 5/00

(52) U.S. Cl. 105/8.1

(57) ABSTRACT

The invention relates to a device for detachably interlinking two vehicle elements (12, 12′) of a vehicle that are arranged in tandem. The inventive device comprises two supporting elements (14, 14′) on ends (16, 16′) of the two vehicle elements (12, 12′) facing each other and connecting devices (18) disposed between the two supporting elements (14, 14′) for transmitting forces between the vehicle elements (12, 12′). At least three connecting devices (18) are provided that are all or all but one adjustable lengthwise and whose ends (20, 20′) are supported via ball joints (22, 22′) on the two supporting elements (14, 14′) via at least three different force transmission points (24, 24′) lying in a common plane in such a manner that tractive, pressure and torsional forces can be transmitted between the two supporting elements (14, 14′) of the two vehicle elements (12, 12′).

The invention relates to a device for detachable interlinking of two vehicle elements of a vehicle arranged in tandem and its application.

Such devices are generally known. For example, DE 197 31 866 Cl describes a coupling device for the detachable interlinking of two waggons of a rail vehicle arranged in tandem. This coupling device comprises two coupling carriers arranged at facing waggon body ends of the two waggons and of two coupling rods disposed between the two coupling carriers for transmission of forces between the waggons. The coupling rods are rigid and designed so that their length cannot be changed. One end of the coupling rods is hinge-connected to a rotary joint. The other end is held by a hydraulic element arranged in the plane of the coupling carriers and which can be moved either vertically or horizontally. Transmission of forces between the coupling carriers to several points arranged at a distance from each other is enabled in this way. The overall constructive design of this coupling device has proven to be a disadvantage. On one hand, the connection between the coupling carriers facing each other is relatively rigid and thus primarily only tractive and pressure forces can be transmitted from one waggon to the other. Although tilt and twist movements between the coupling carriers are possible, this can only be achieved to a very limited degree. On the other hand, the sliding movement is relatively small because of the hydraulic elements arranged in the particular plane of the coupling carriers. To this extent, larger relative movements of the waggons, whether in the horizontal direction or vertical direction are precluded. A connection of this kind which is overall very rigid and has little flexibility therefore does not enable movements of the waggons relative to each other to be individually allowed for. Accordingly, for example, the loss of a bandage or even of a complete bogie cannot be taken up. Furthermore, individual waggons jolting against each other with a so-called concertina effect can also not be prevented.

The object of the invention is therefore to provide a device for the detachable interlinking of two vehicle elements of a vehicle arranged in tandem, by means of which the above disadvantages can be prevented, which is nevertheless of particularly simple design and at the same time compact and stable and yet enables relative movement between the individual neighbouring vehicle elements of a vehicle in a defined manner and also facilitates advantageous application of this device.

This object is technically achieved by the device with the features of claim 1.

Accordingly, by the arrangement of the inventive device for the detachable interlinking of two vehicle elements of a vehicle arranged in tandem with two supporting elements at the ends of the two facing vehicle elements and connecting devices for the transmission of forces disposed between the two supporting elements, with at least three connecting devices being provided that are lengthwise adjustable either together or with the exception of a single one and whose ends in each case are supported by ball joints at two supporting elements through at least three force transmission points, in the same plane and separate from each other, in such a way that tractive, pressure and torsional forces can be transmitted between the two supporting elements of the two vehicles elements, a particularly simple overall construction of a device, which is also compact, is achieved. Furthermore, this inventive device is of particularly stable construction. Finally, the inventive device has the main advantage of fulfilling the present safety standards in a satisfactory manner and of being able to make individual compensating relative movements between individual vehicle elements of the vehicle. The coupling of two neighbouring vehicle elements of a vehicle is rigid and interlocked. But at the same time compensating movements by the connecting devices of the inventive device can be taken up and can, if required, be individually damped, actively controlled, pre-tensioned or corrected in another manner. In this way a pre-defined running behaviour of the vehicle, for example of an articulated train overall, is enabled. Finally, a cost-effective manufacture of the inventive device is also enabled.

Further advantageous details of the inventive device are described in claims 2 to 32. Of particular significance for a simple, reliable construction and also a flexible compensation of suddenly-occurring relative movements of the vehicle elements of a vehicle relative to each other and thus a reaction in real time, are the measures according to claim 2 whereby the connecting device has a rod-type connecting element that is telescopically lengthwise adjustable, with its ends being supported directly via the ball joints on two supporting elements.

Alternatively, or in addition, the connecting device according to the features of claim 3 can also have a rod-type connecting element of constant length, with at least one end, preferably both ends, of the connecting element being supported via the ball joint on the assigned supporting element with a lengthwise adjusting element arranged between them.

Without impairing the functional capability whilst at the same further simplifying the construction, it is furthermore possible in this connection for one of the connecting devices in accordance with claim 4 to have a rod-type connecting element of constant length, with its ends being directly support via the ball joints on two supporting elements.

Furthermore, in accordance with this invention it is possible in accordance with claims 5 and 6 for the connecting device in the lengthwise direction to be arranged essentially vertical, or at an angle, relative to the planes covered by at least three force transmission points. In this case the connecting device arranged at an angle to plane covered by at least three force transmission points runs diagonally.

If the vehicle for which the device in accordance with the invention is intended as a water vehicle, three connecting devices are generally completely sufficient for the transmission of all the tractive, pressure and torsional forces between the two supporting elements of the two vehicle elements in accordance with claim 7.

The inventive device in accordance with claim 8, that has five connecting devices for transmission of tractive, pressure and torsional forces disposed between the two supporting elements of the two vehicle elements is suitable in a quite advantageous manner for a land vehicle and thus particularly for a rail vehicle.

In this connection, as part of the invention, the five connecting devices corresponding to the features of claims 9 and 10 can each be designed as an adjustable lengthwise, rod-type connecting element or, alternatively, designed as two adjustable lengthwise, rod-type connecting elements arranged diagonally between the two supporting elements, and with three rod-type connecting elements of constant length each being provided with a length-adjusting element. If on the other hand the vehicle to be fitted with the inventive device is an aircraft or a missile designed for space, then according with the invention, six connecting devices can be provided to transmit tractive, pressure and torsional forces between the two supporting elements of the two vehicle elements. On one hand, in this manner the construction expense and thus also the weight of the inventive device can be kept low and on the other hand individual compensation for relative movements between the two vehicle elements can be ensured in a satisfactory manner.

For additional generation of pre-tension between the two supporting elements of the two vehicle elements, it is provided in accordance with the invention as per claim 12 to arrange a further connecting device between the two supporting elements. Of quite particular interest for a rigid and fixed connection that at the same time provides a fast and individual compensation for relative movements of the vehicle elements with respect to each other, are the measures in accordance with claim 13, in accordance with which twelve connecting devices act between the two supporting elements of the two vehicle elements of the vehicle. An arrangement of this type is of great significance, particularly for vehicles on land, such as rail vehicles. It is thus possible in this way to compensate for the loss of a bandage or even of a complete bogie. A railway accident such as that at Eschede can thus be safely avoided. Even if a bandage breaks away, the vehicle element still intact would be able to take over the necessary supporting function due to the stable coupling based on the inventive device. For example, it is completely conceivable in such a case for the defective vehicle element to be raised slightly by the still intact vehicle element by means of the inventive device. The jolting together with a so-called concertina effect, as happened in the railway accident at Brühl/Bonn, could be safely prevented.

Advantageous in this case are four transmission points at each section element in accordance with claim 14 are provided, that are arranged on an imaginary circle or at the corners of an imaginary square or right angle or other polygon, to link three ends in each case of three of the twelve connecting devices.

The structural design corresponding to the measures of claims 15 to 17, in accordance with which finally the transmission points at the two section elements lie essentially in their edge area and the connecting devices run in planes that are parallel to the supporting elements, basically enables the arrangement of a crossing for persons between two adjacent vehicle elements without the crossing for persons being un-necessarily impeded, for example by diagonal connecting devices. To enable such a crossing for persons, a walkway or similar crossing is provided between the two supporting elements and the connecting devices between the two supporting elements in accordance with claim 18. By means of the measures in accordance with claim 19 and 20, i.e. of connecting the two supporting elements by an intermediate lengthwise-elastic bellows, which encloses the connecting devices at least on the outside, in particular also additionally. on the inside, the device 10 in accordance with the invention is protected against deposits of dust, dirt etc. and also against corrosion due to the ingress of water, for example salt water. Therefore it follows that the service life of the inventive device can be substantially increased.

Furthermore, it is within the framework of the invention, to be able to operate the adjustable lengthwise connection device in accordance with claim 21 hydraulically, pneumatically, mechanically or electrically. The individual open-circuit control, or under certain circumstances also a provided closed-circuit control, of the particular connecting device can be quickly achieved, i.e. substantially in real time, without additional design expense and also with increased reliability.

In this connection, the adjustable lengthwise connecting device in accordance with claim 22 appropriately includes a hydraulic unit, pneumatic unit, linear unit, spindle unit, a linear motor or similar. By means of a hydraulic unit, such as a hydraulic cylinder for example, the connecting devices are controlled by a corresponding build up in pressure in two opposite chambers, whose adjustment can be controlled by a travel measuring system. A defined position of the particular connecting device can be obtained. By means of the arrangement in accordance with the invention according to claims 23 and 24 where the two supporting elements with at least three connecting devices arranged between them are integrally mounted to the ends of the two facing vehicle elements, with at least one supporting element being detachably interlinked to the allocated end of one of the two vehicle elements, a construction which is overall simple and stable results. The inventive device can be integrated with the particular vehicle element. At the same time, it is of course ensured that a decoupling of two detachably interlinked vehicle elements can take place at any time.

As an alternative, it is also possible as part of the invention for the two supporting elements in accordance with claim 25 with at least three connecting devices between them to be detachably interlinked as a quasi-structural unit with the ends of the two facing vehicle elements. In this way, it is not absolutely necessary for each vehicle element to be equipped with an inventive device in order to form a vehicle consisting of a number of vehicle elements. It is therefore, for example, conceivable that an inventive device is available at a location at which the vehicle is to be assembled from several individual vehicle elements, the inventive device after reaching the location at which the vehicle, for example is to be split up, to be again decoupled and kept ready at this location for a new use.

In accordance with the features of claims 26 to 29, it is provided in accordance with the invention for this purpose that the two supporting elements at the two facing ends of the two vehicle elements could be mounted precisely in position, attached and secured by means of friction and/or form-interlocking connections, formed perhaps as swallow tail or also key and keyway connections. Of particular interest for a simple, and under certain circumstances central and precisely-determinable control of the inventive device are the design measures according to claims 30 and 31, according to which the connecting devices communicate with at least one control device with regard to their open-circuit or closed-circuit control, and are matched to each other either individually in each case or all together.

In order as far as possible to allow, if required, for the geographic conditions etc. already pertaining, with regard to open-circuit or closed-circuit control, at least one control device in accordance with claim 32 is fitted with a transmitting/receiving device for control by means of radio and/or GPS (global positioning system) or GSM (groupe speciale mobile) standard and/or infrared.

Finally, within the context of the invention corresponding to claim 33, an inventive device can be used for the detachable interlinking of two vehicle elements of interlinked vehicles arranged in tandem, on land, on water, in the air and in space. In particular, in this case the use in high-speed trains, as already explained, is considered. It is however also possible to use the inventive device in inland navigation. By a controlled steering movement of the inventive device, either more vehicle elements can be used and/or smaller turning radii enabled in a multiple-barge convoy set. From this it follows that a greater load capacity is ensured. Equally conceivable is the use of the inventive device in deep-sea navigation. By means of an active control system, tankers can, for example, be broken down into segment-connected cargo ships. A greater load capacity results because of the removal of the length restriction of the individual vehicle elements due to an improved steerability. Further uses of the inventive device are also in aerospace. trams, freight trains and in road traffic. Overall the safety standards can be substantially improved, and therefore also the safety and thus bodily harm or accidents with a fatal outcome for humans can be largely avoided.

Further features, advantages and details of the invention are given in the following description of some preferred embodiments of the invention and also by using drawings. The drawings are as follows:

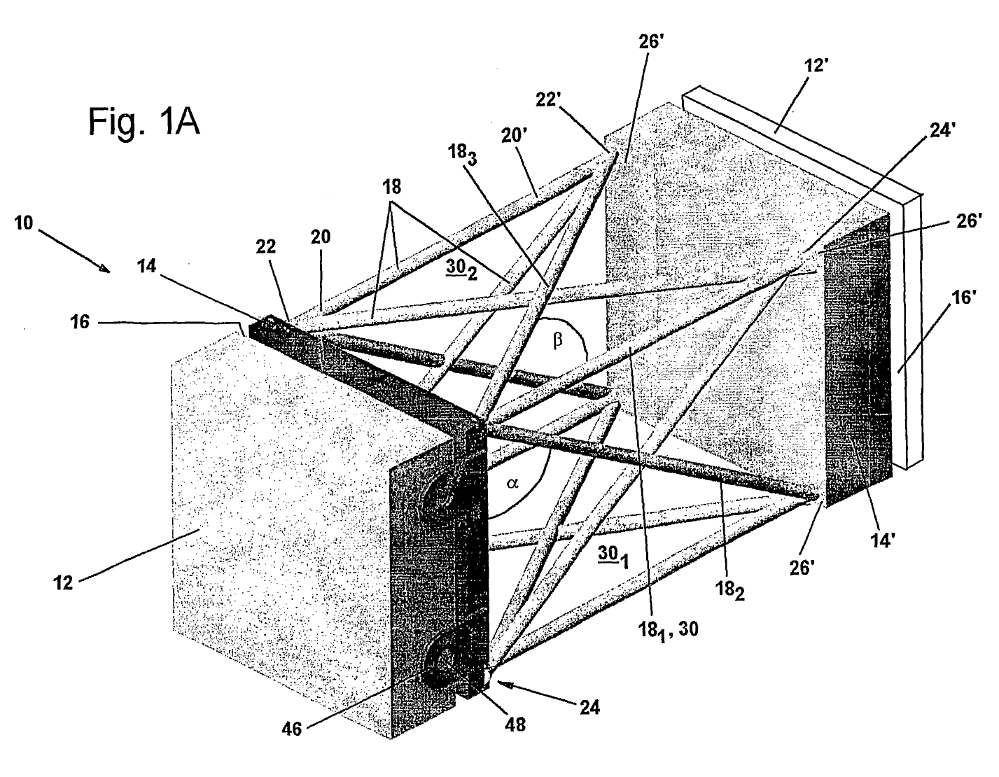

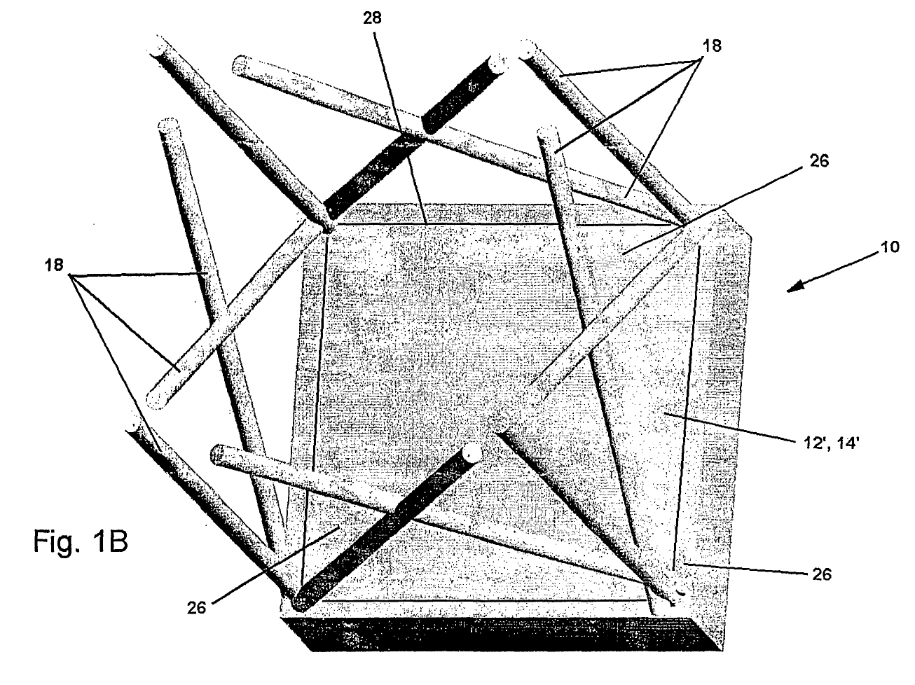

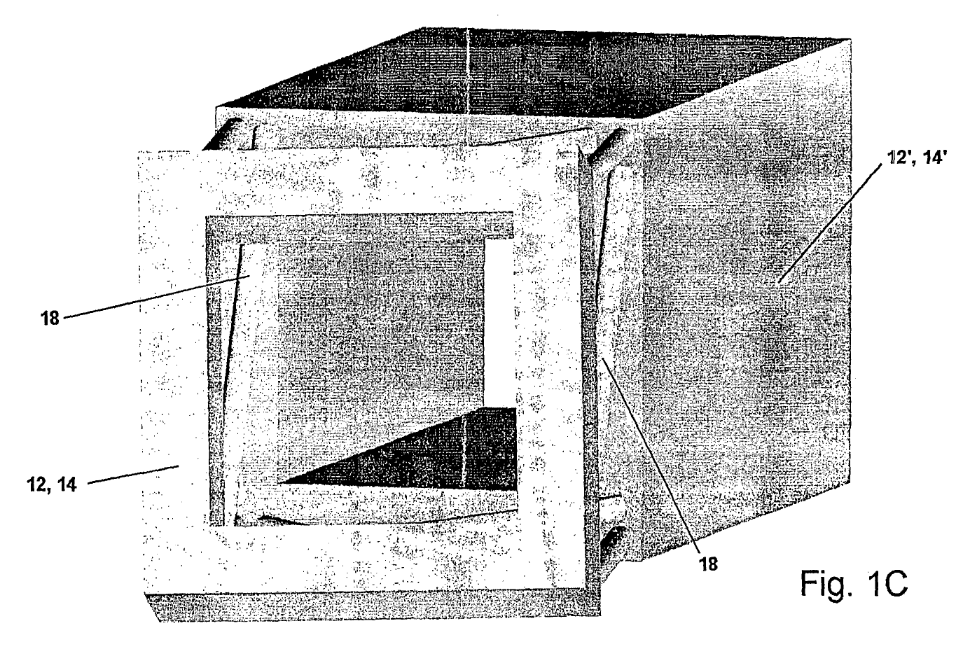

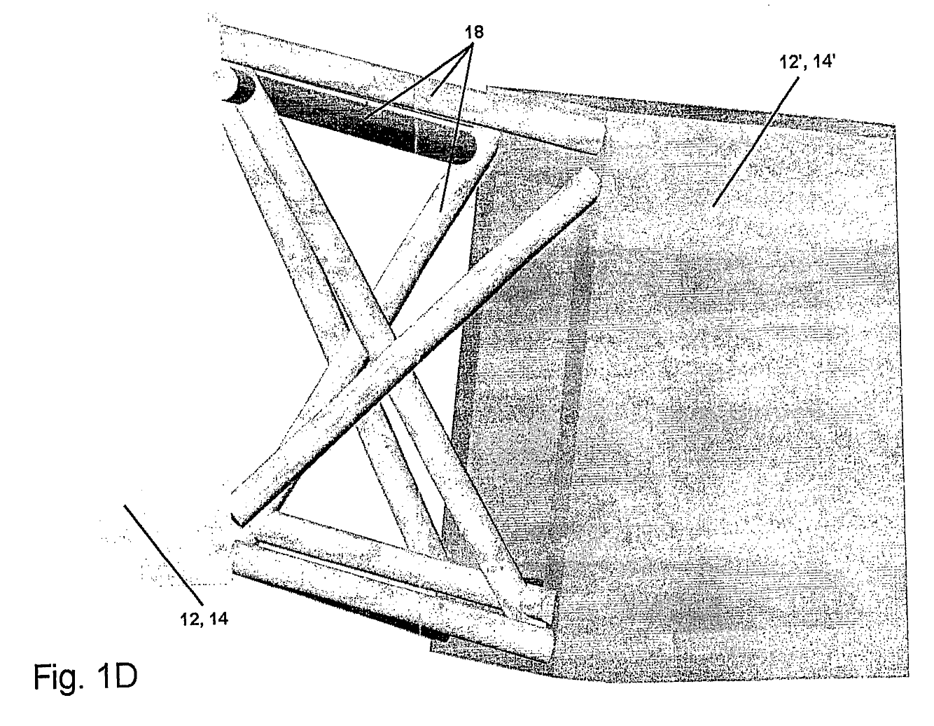

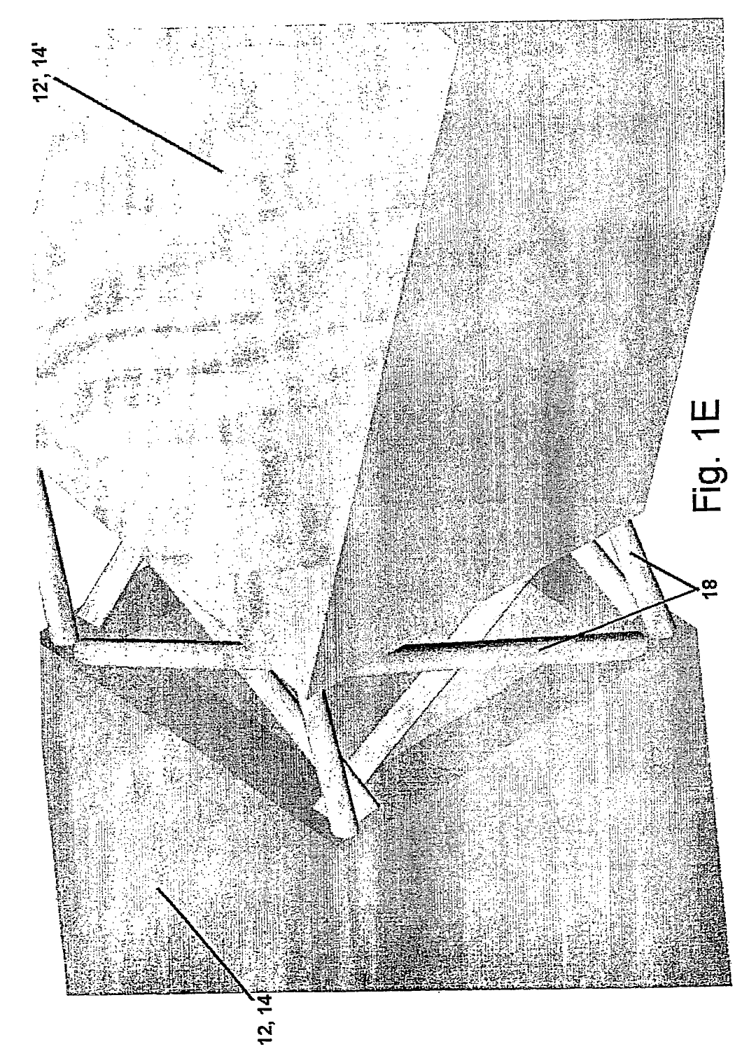

FIG. 1A A schematic perspective view of a first form of embodiment of an inventive device for the detachable interlinking of two vehicle elements of a vehicle arranged in tandem,

FIG. 1B a partly cut away schematic perspective view of an embodiment of the inventive device for the detachable interlinking of two vehicle elements of a vehicle arranged in tandem in accordance with FIG. 1A,

FIG. 1C to 1E various partly cut away schematic perspective views of the embodiment of the inventive device in accordance with FIG. 1A and 1B showing various positions relative to each other of the two vehicle elements of the vehicles arranged in tandem,

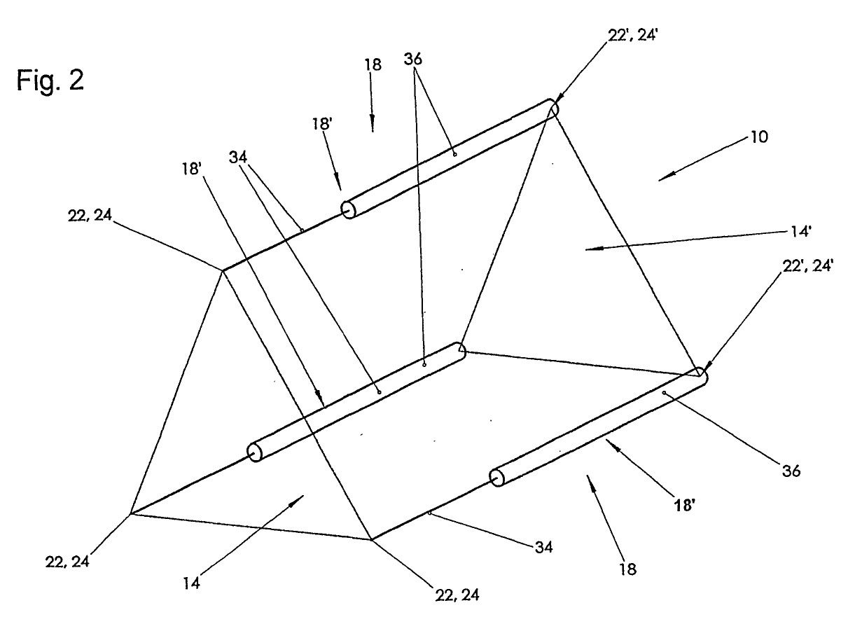

FIG. 2 a schematic perspective view of another form of embodiment of the invention for detachable interlinking of two vehicle elements of a vehicle arranged in tandem,

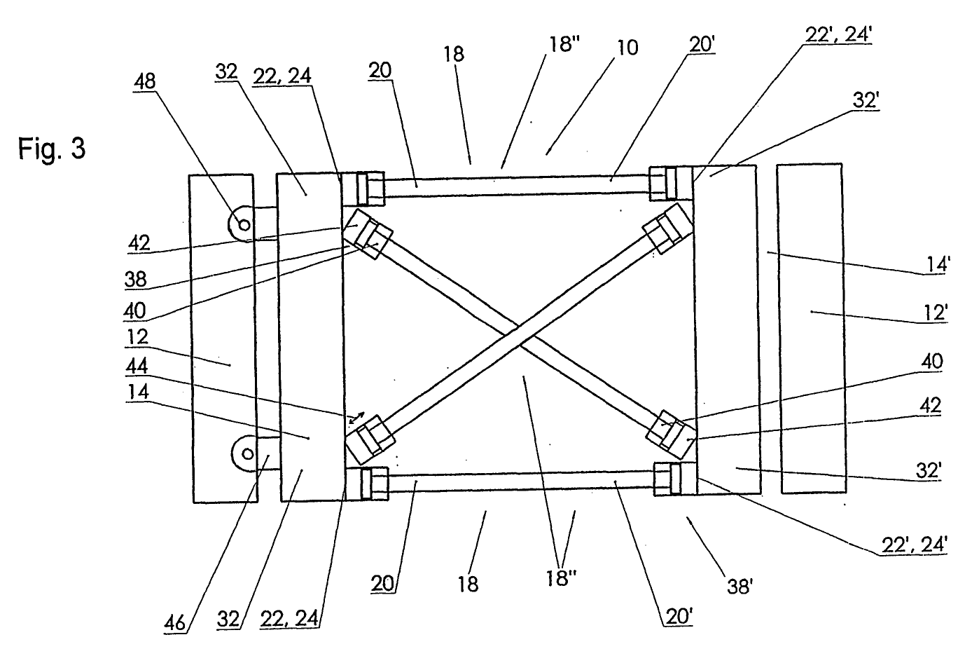

FIG. 3 a partial cut away plan view of a further form of embodiment of an inventive device for the detachable interlinking of two vehicle elements of a vehicle arranged in tandem corresponding to FIG. 1A,

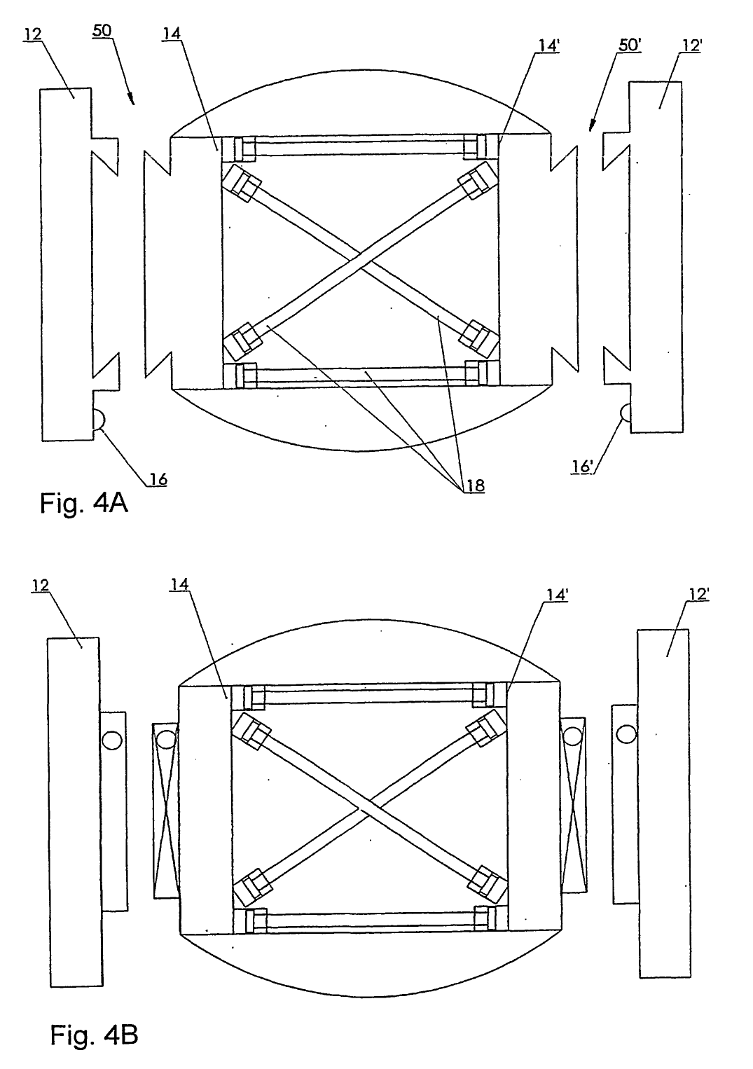

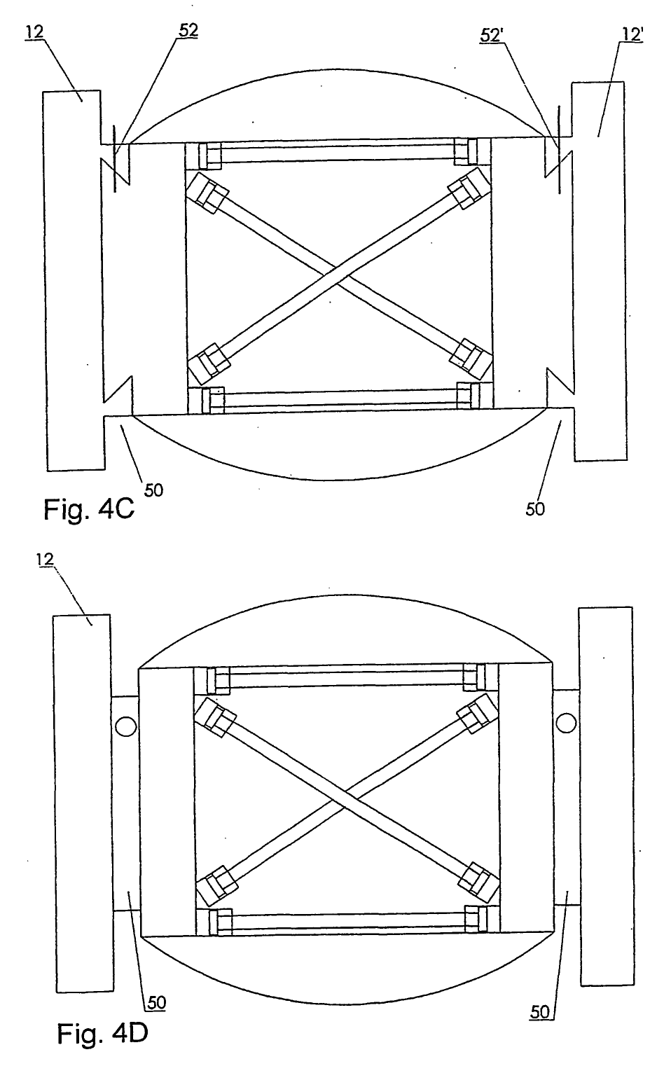

FIG. 4A to 4D a partly cut away schematic plan and side views of a modified form of the embodiment of the inventive device for the detachable interlinking of two vehicle elements of a vehicle arranged in tandem in accordance with FIG. 3, with the inventive device shown in the unmounted state in FIG. 4A and 4B and in the mounted state in FIG. 4C and 4D,

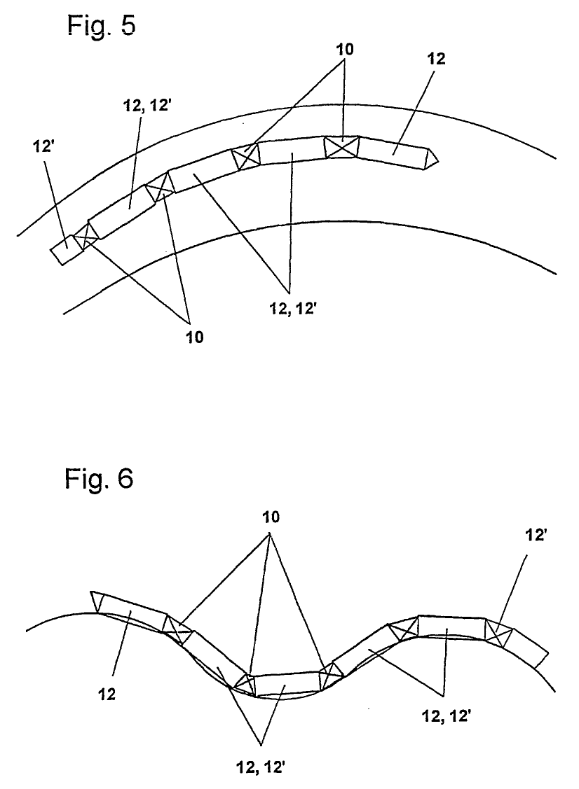

FIG. 5 a schematic plan view of a linked vehicle for waterborne use with a number of vehicle elements arranged in tandem with inventive devices disposed between them in accordance with FIG. 1 to 4D, and

FIG. 6 a schematic side view of a linked vehicle for waterborne use with an number of vehicle elements arranged in tandem and inventive devices according to FIG. 1 to 4D arranged in between.

The inventive device 10 is provided for the detachable inter-linking of two vehicle elements 12, 12′ of a vehicle arranged in tandem. In the following description of various examples of embodiments of the inventive device 10, components which are the same as each other are provided with identical reference characters in each case.

The device 10 in accordance with the invention is particularly suitable for the detachable connection of two vehicle elements 12, 12′ of linked vehicles arranged in tandem, on land, such as goods vehicles with trailers, particularly rail vehicles such as passenger and goods trains or trams, on water, such as a push tow convoy of several container ships, in the air and in space.

FIG. 1A, 1B, 1C, 1D and 1E is a schematic representation of a first form of the embodiment of such an inventive device 10. The device 10 in this case has two supporting elements 14, 14′ at two facing ends 16, 16′ of the two vehicle elements 12, 12′, i.e. the front vehicle element 12 and the rear vehicle element 12′.

Furthermore, the inventive device 10 has at least three connecting devices 18. The connecting devices 18 are arranged between the two supporting elements 14, 14′ and serve to transmit the forces between the supporting elements 14, 14′ and thus the vehicle elements 12, 12′ themselves. The connecting devices 18 are all, or with the exception of a single one, lengthwise adjustable. With the form of embodiment shown in FIG. 1A to 1E, all the connecting elements can be increased or shortened in length. The ends 20, 20′ of the connecting devices 18 are each supported by ball joints 22, 22′ on the two supporting elements 14, 14′ via at least three force transmission points 24, 24′. The force transmission points 24, 24′ in this case differ from each other but lie in a common plane. With present form of embodiment of the inventive device 10 in accordance with FIG. 1A to 1E, the ball joints 22, 22′ are identical to the force transmission points 24, 24′. Therefore the two supporting elements 14, 14′ and the planes covered by the force transmission points 24, 24′ also coincide. On the other hand it is, however, also possible that the ball joints 22, 22′ do not coincide with the force transmission points 24, 24′ at which the forces to be transmitted via the connecting devices 18 to the two supporting elements 14, 14′ are introduced. A form of embodiment of this kind is further described below.

Due to the lengthwise adjustability of the connecting devices 18 on one hand and the support of the ends 20, 20′ of the connecting devices 18 by at least three separate force transmission points 24, 24′ lying in a common plane on the other, a structure results which enables tractive, pressure and torsional forces to be transmitted between the two supporting elements 14, 14′ of the two vehicle elements 12, 12′. With the form of embodiment of the inventive device 10 shown in FIG. 1A to 1E, each connecting device 18 is arranged essentially vertical in the lengthwise direction or at an angle α, β to the planes covered by the two supporting elements 14, 14′. In the example of an embodiment shown in FIG. 1A to 1E, each connecting device 18 that is arranged at an angle α, β to the planes covered by the two supporting elements 14, 14′ extends diagonally.

In particular, with the form of embodiment of the inventive device 10 in accordance with FIG. 1A to 1E there are a total of twelve connecting devices 18 between the two supporting elements 14, 14′ arranged between the two vehicle elements 12, 12′ of the vehicle. In this case there are four force transmission points 24, 24′ provided at each supporting element 14, 14′. The four force transmission points 24, 24′ are arranged on an imaginary circle or, as in this case, the corners 26, 26′ of an imaginary square 28, 28′, right angle or other polygon. Three ends 20, 20′in each case of three of the twelve connecting devices 18 are hinge-mounted at the force transmission points 24, 24′via corresponding ball joints 22, 22′ to allow free movement in a three-dimensional direction. Each of the three connecting devices 18 are arranged between the two supporting elements 14, 14′ in planes that in each case are vertical to the common plane of the force application points 24, 24′, i.e. vertical to the supporting element 14, 14′ in the illustrated example of an embodiment, and at the same time run through an allocated force application point 24, 24′. To this extent, a 18₁ of each of the three connecting devices 18 is located on the intersection line 30 of two planes 30₁, 30₂ positioned vertical relative to each other. The two further 18₂, 18₃ of each of the three connecting devices 18 on the other hand extend diagonally in two planes 301, 302 vertical relative to each other. In other words, the connecting device 181 extends from the top right ball joint 22 or force transmission point 24 at the front supporting element 14 to the upper right ball joint 22′or force transmission point 24′ at the rear supporting element 14′ on the intersection line 30 of the two planes 30₁, 30₂, the connecting device 182 from the upper right ball joint 22 or force transmission point 24 at the front supporting element 14 to the bottom right ball joint 22′ or force transmission point 24′ at the rear supporting element 14′, diagonally in the plane 30₁, the connecting device 18₃ from the top right ball joint 22 or force transmission point 24 at the front supporting element 14 to the top left ball joint 22′ or force transmission point 24′ at the rear supporting element 14′ diagonally in the plane 30₂, etc. Because the planes covered by force transmission points 24, 24′ coincide with the two supporting elements 14, 14′, the connecting devices 18 therefore run in planes 30₁, 30₂ that are vertical to the supporting elements 14, 14′. The connecting devices 18 are completely shifted to the edge areas 32, 32′ of the supporting elements 14, 14′. On the contrary, it is however basically also possible to arrange one or more connecting devices 18 in planes that do not run with the planes 30₁, 30₂, i.e. essentially vertical to the supporting elements 14, 14′.

In this connection it is, for example, conceivable to hinge-mount a first connecting device 18 between the top right ball joint 22 or force transmission point 24 at the supporting element 14 and the bottom left ball joint 22′ or force transmission point 24′ at the supporting element 14′, and to hinge-mount a second connecting device 18 from the top left ball joint 22 or force transmission point 24 at the supporting element 14 and the bottom right ball joint 22′ or force transmission point 24′ at the supporting element 14′ etc. (not illustrated).

The form of embodiment of the inventive device 10 in accordance with Fig. 1A to 1E certainly has the additional advantage compared with the last mentioned form of embodiment that between the two supporting elements 14, 14′ and the connecting devices 18 between the two supporting elements 14, 14′ a walkway or similar crossing (not illustrated) can be provided. In this way it is therefore possible for personnel and/or passengers, while transported by such a vehicle, to change from one vehicle element 12 to a neighbouring vehicle element 12′ and vice versa. Where a crossing for persons between two neighbouring vehicle elements 12, 12′ is possible it would not be unnecessarily hindered by diagonal connecting devices 18. Without being shown in detail, it is particularly useful in this connection for the two supporting elements 14, 14′ to be connected by means of an interposed lengthwise-elastic bellows. In this case the bellows can at the same time enclose the connecting devices 18 at least externally, and in particular also internally, so that the inventive device 10 can be completely protected against dirt, dust, water, such as salt water, and similar substances. The functionality of the inventive device 10 is not impaired by this. Its service life is, however, substantially increased. The form embodiment of the inventive device 10 shown in Fig. 1A to 1E is particularly suitable for detachable interlinking of two vehicle elements 12, 12′ of a land vehicle and in this case particularly a rail vehicle. By means of the inventive device 10, the neighbouring vehicle elements 12, 12′ can be rigidly connected to each other, thus improving utilisation for traffic purposes and providing advantages with regard to safety standards.

Thus, for example, with the aid of the previously described form of embodiment of the inventive device 10 even the loss of a bandage or even a complete bogie could be taken up by a rail vehicle. A railway accident similar to that occurring at Eschede could be safety avoided in this manner. Furthermore, individual vehicle elements 12, 12′ of vehicles pushing or jolting against each other due to the so-called concertina effect is precluded. Therefore, the use of an inventive device 10 means that a railway accident such as that at Brühl/Bonn can no longer occur.

If the form of embodiment of the inventive device 10 in accordance with FIG. 1A to 1E also has a total of twelve connecting devices 18, it is also completely conceivable to provide only five connecting devices 18 for transmission of tractive, pressure and torsional forces between the two supporting elements 14, 14′ of the two vehicle elements 12, 12′, provided the inventive device 10 is intended for a land vehicle, particularly a rail vehicle. An equal functional capability from a technical point of view is achieved.

The actual lengthwise adjustability of connecting devices 18 with the form of embodiment of the inventive device 10 in accordance with FIG. 1A to 1E can basically be realised by two arrangements, which are dealt with in more detail in the following in conjunction with the forms of embodiment in accordance with FIG. 2 and/or 3. FIG. 1C to 1E show the supporting elements 14, 14′ in various positions relative to each other, with the connecting devices 18 ensuring a rigid coupling of the vehicle elements 12, 12′.

FIG. 2 shows a form of embodiment of the inventive device 10 that has only three connecting devices 18 to transmit tractive, pressure and torsional forces between the two supporting elements 14, 14′ from two vehicle elements 12, 12′ of a water vehicle, for example a ship.

The two supporting elements 14, 14′ or the planes covered by the ball joints 22, 22′ or associated force transmission points 24, 24′ are designed in the form of a triangle of equal sides. Even if a different arrangement of the connecting devices 18 between the supporting elements 14, 14′ is conceivable, such a design concept has shown itself to be particularly advantageous because the application of the force from one supporting element 14 or 14′ to the other supporting element 14′ or 14 can take place in a decidedly uniform manner.

All of the three connecting devices 18 in this case are adjustable lengthwise. For this purpose, each of the three connecting devices 18 includes a rod-type connecting element 18′ that is telescopically adjustable lengthwise. The rod-type connecting element 18′ in this case includes a piston rod 34 or similar rod and a sleeve 36 holding the piston rod 34. The ends 20, 20′ are supported directly on the two supporting elements 14, 14′ via the ball joints 22, 22′.

The lengthwise adjustable connecting devices 18 in this case can be actuated hydraulically, pneumatically, mechanically or electrically. For this purpose, the lengthwise adjustable connecting device 18 with the lengthwise adjustable connecting element 18′ has, for example, a hydraulic unit, pneumatic unit, linear unit, spindle unit or also a linear motor (not shown in detail).

FIG. 3 shows a further form of embodiment of an inventive device 10. The inventive device 10 in accordance with FIG. 3 is fitted with five connecting devices 18, of which of course only four connecting devices 18 are visible. The fifth connecting device 18 is, for example, covered by the other connecting devices 18 next to the bottom edge in FIG. 3.

Alternatively, or also in addition to the constructive embodiment of the connecting devices 18 in accordance with FIG. 2, a rod-type connecting element 18′′ of constant length is provided in the case of the embodiment of the connecting devices 18′. At least one end 20, 20′ of the rod-type connecting element 18′′ is supported by the ball joint 22, 22′ and with a length adjusting element 38, 38′ arranged in between which is allocated to the particular supporting element 14, 14′.

Even if basically only one length adjusting element 38, 38′ at one of the two ends 20, 20′ of the rod-type connecting element 18′′ is sufficient for lengthwise adjustment of the connecting devices 18, the technical implementation of a length adjusting element 38, 38′ at each of the two ends 20, 20′ enables a faster adjustment or change in length of the particular connecting device 18 to be achieved.

The length adjusting element(s) 38, 38′ of the lengthwise adjustable connecting device 18 is (are), in a corresponding manner to the lengthwise adjustable rod-type connecting element 18′ of the connecting device 18, hydraulically, pneumatically, mechanically or electrically actuatable. To this extent, the lengthwise adjustable connecting device 18 with the length adjusting element(s) 18′ equally has a hydraulic unit, pneumatic unit, linear unit, spindle unit or linear motor.

As can be seen from FIG. 3, with the form of embodiment of the inventive device 10 all length adjusting elements 38, 38′ are designed as hydraulic cylinders, whereby a position 40, 42, controlled and thus defined by a travel measuring system 44, due to the corresponding pressure build up, can be maintained. Without being illustrated in detail, an inventive device 10 with a total of six connecting devices 18 for transmission of tractive, pressure and torsional forces between the two supporting elements 14, 14′ of two vehicle elements 12, 12′ is suitable if the vehicle is an aircraft or missile in space.

In order to move two facing supporting elements 14, 14′ relative to each other in the atmosphere or in space, i.e. to change the planes covered by the supporting elements 14, 14′ relative to each other, at least six such connecting devices 18 are necessary because of the existing degrees of freedom. In order in the case of one or more forms of embodiment of the inventive device 10, which were described in FIG. 2 and 3 and/or also without reference to corresponding figures, to create a pre-tension between the two supporting elements 14, 14′ of the vehicle elements 12, 12′ adjacent to each other, a further connecting device 18 is necessary. Only with the form of embodiment of the inventive device 10, shown in FIG. 1A to 1E, is such an additional connecting device 18 not necessary due to the number of connecting devices 18 already present.

It is generally possible to integrally fit the two supporting elements 14, 14′, with at least three connecting devices 18 interposed between, to the facing ends 16, 16′ of the two vehicle elements 12, 12′. The advantage of such a constructive design is that at least one supporting element 14, 14′ is detachably interlinked with the allocated end 16, 16′ of one of the two vehicle elements 12, 12′ of the vehicle. Only in this way is a variable and versatile coupling possible, without which economic operation of linked vehicles on land, for example freight trains, or on water, such as for example, push-tow ship convoys consisting of several container ships, is not possible. By way of example, with the form of embodiment of the inventive device 10 in accordance with FIG. 1 and/or 3, a supporting element 14 is shown that has side flanges 46 with corresponding holes 48 by means of which the supporting element 14 is detachably connected to the corresponding vehicle 12 by means of pins, bolts or similar attaching parts (not illustrated).

A particularly advantageous alternative to this is the constructive design of the form of embodiment of the inventive device 10 in accordance with FIG. 4A to 4D. According to this, the two supporting elements 14, 14′ with at least three connecting devices 18 arranged in between are detachably secured to facing ends 16, 16′ of the two vehicle elements 12, 12′. The two supporting elements 14, 14′ are secured to the facing ends 16, 16′ by frictional and/or shape-interlocking connections 50, 50′ for precise positioning. Swallow tail connections in accordance with the form of embodiment in FIG. 4A to 4D are provided as frictional and/or shape-interlocking connections 50, 50′. It is also conceivable to use key and keyway connections as shape-interlocking connections 50, 50′. It is also possible to use bolted joints, or instead of these magnetic connections or similar, as frictional and/or shape-interlocking connections.

The two supporting elements 14, 14′ for the form of embodiment in accordance with FIG. 4A to 4D with at least three connecting devices 18 arranged between them can be installed either vertically from above or horizontally from the side at the ends 16, 16′ of the two vehicle elements 12, 12′ shape-interlocking connections 50, 50′ provided and with this then secured against automatic disconnection by bolts 52, 52′, pins, screws or other detent, snap or similar devices (not illustrated). Without being shown in detail, the connecting devices 18 are also connected with at least one control device for open-loop or closed-loop control. The connecting devices 18, i.e. the lengthwise adjustable rod-type connecting elements 18′ and/or the length adjusting elements 18′′ are in this case adjustable with at least one control device either individually in each case or all tuned to each other. Balancing movements applied from outside to the two vehicles elements 12, 12′ of the vehicle can be immediately compensated for by the inventive device 10 and if required, be suitably damped, actively controlled, pre-tensioned or corrected in some other manner in real time. In this way, the vehicle receives a predefined, or also predefinable, running characteristic. For example, it is possible with the inventive device 10 to obtain a controlled steering movement. To this extent, a deliberate steering of the vehicle is possible. Substantially smaller steering radii can be achieved. It necessarily follows from this that there is the possibility of operating multiple-barge convoy sets or push-tow ship convoys which were longer than previously possible and/or permitted, both for inland navigation in accordance with FIG. 5 and also for deep-sea navigation in accordance with FIG. 6. The removal of the length restrictions means that larger load capacities are achieved.

Finally, at least one control device can additionally be provided with a transmitting/receiving device for control by means of radio and/or GPS (global positioning system) or GSM (groupe speciale mobile) standard and/or infrared.

The inventive device 10 is not restricted to the previous examples of embodiments. For design simplification it is, for example, also conceivable to design the at least three connecting devices 18 as a rod-type connecting element of constant length, the ends of which 20, 20′ each has a ball joint 22, 22′ that coincides with the force transmission points 24, 24′ at the particular supporting element 14, 14′ or the associated plane. As an alternative it is also possible, instead of such a connecting device 18 with a rod-type connecting element of constant length and ball joint elements 22, 22′ arranged at the ends, to provide two rod-type connecting elements one end of each of which is rigidly fixed to the associate supporting element 14 and/or 14′ and with their other facing ends, connected by a common ball joint.

1. Device for the detachable interlinking of two vehicle elements (12, 12′) of a vehicle arranged in tandem with two supporting elements (14, 14′) on facing ends (16 16′) of the two vehicle elements (12, 12′) and connecting devices (18) disposed between the two supporting elements (14, 14′) for transmitting forces between the vehicle elements (12, 12′), with at least three connecting devices (18) are provided that are all, or with the exception of a single one, adjustable lengthwise and whose ends (20, 20′) are supported via ball joints (22, 22′) on the two supporting elements (14, 14′) via at least three different force transmission points (24, 24′) lying in a common plane in such a manner that tractive, pressure and torsional forces can be transmitted between the two supporting elements (14, 14′) and the two vehicle elements (12, 12′).

2. Device in accordance with claim 1, characterised in that the connecting device (18) comprises a rod-type connecting element (18′) that is telescopically adjustable lengthwise, with its ends (20, 20′) being directly supported via the ball joints (22, 22′) on two supporting elements (14, 14′).

3. Device in accordance with claim 1 or 2, characterised in that the connecting device (18) comprises a rod-type connecting element (18′′) of constant length, with at least one end (20, 20′) of the connecting element (18′′) being supported via the ball joint (22, 22′) on the associated supporting element (14, 14′) with a length adjusting element (38, 38′) arranged between them.

4. Device in accordance with one of claims 1 to 3, characterised in that one of the connecting devices (18) comprises a rod-type connecting element of constant length, with its ends being supported directly on two supporting elements (14, 14′) via the ball joints (22, 22′).

5. Device in accordance with one of claims 1 to 4, characterised in that the connecting device (18) is arranged in the lengthwise direction essentially vertical or at an angle of (α,β) to the planes covered by at least three force transmission points (24, 24′).

6. Device in accordance with claim 5, characterised in that the connecting device (18) extends at an angle of (α,β) to the planes covered by at least three force transmission points (24, 24′).

7. Device in accordance with one of claims 1 to 6, characterised in that three connecting devices (18) are arranged for the transmission of tractive, pressure and torsional forces between the two supporting elements (14, 14′) of the two vehicle elements (12, 12′) of a water vehicle.

8. Device in accordance with one of claims 1 to 6, characterised in that five connecting devices (18) are arranged for the transmission of tractive, pressure and torsional forces between the two supporting elements (14, 14′) of the two vehicle elements (12, 12′) of a land vehicle, particularly a rail vehicle.

9. Device in accordance with claim 8, characterised in that the five connecting devices (18) each have a lengthwise adjustable, rod-type connecting element (18′).

10. Device in accordance with claim 8, characterised in that the five connecting devices (18) are formed from two lengthwise adjustable, rod-type connecting elements (18′), that are arranged diagonally. between the two supporting elements (14, 14′), and three rod-type connecting elements (18′′) of constant length each with a length adjusting element (40, 40′).

11. Device in accordance with one of claims 1 to 6, characterised in that six connecting devices (18) are arranged for the transmission of tractive, pressure and torsional forces between two supporting elements (14, 14′) of the two vehicle elements (12, 12′) of an aircraft, or a missile in space.

12. Device in accordance with one of claims 7 to 11, characterised in that a further connecting device (18) is provided to generate a pre-tension between the two supporting elements (14, 14′).

13. Device in accordance with one of claims 1 to 6, characterised in that twelve connecting devices (18) are arranged between the two supporting elements. (14, 14′) of the two vehicle elements (12, 12′) of the vehicle.

14. Device in accordance with claim 13, characterised in that four force transmission points (24, 24′) are provided at each supporting element (14, 14′) that are arranged on an imaginary circle or at the corners (26, 26′) of an imaginary square (28, 28′), right angle or other polygon for control of three ends (20, 20′) each of three of the twelve connecting devices (18).

15. Device in accordance with claim 14, characterised in that three connecting devices (18) each are arranged between the two supporting elements (14, 14′) in planes that each run vertical to the common plane of the force transmission points (24, 24′) and through the one associated force transmission point (24, 24′).

16. Device in accordance with claim 15, characterised in that one (18₁) of the three connecting devices (18) in each case on the intersection line (30) of two planes (30₁, 30₂) standing vertically on each other and the two further (18₂, 18₃) three connecting devices (18) in each case extend diagonally in the two planes (30₁, 30₂) standing vertically on each other.

17. Device in accordance with one of claims 1 to 16, characterised in that the force transmission points (24, 24′) on the two supporting elements (14, 14′) are located essentially in their edge area (32, 32′) and the connecting devices (18) run in planes standing vertical to the supporting elements (14, 14′).

18. Device in accordance with claim 17, characterised in that a walkway or similar crossing is provided between the two supporting elements (14, 14′) and the connecting devices (18) between the two supporting elements (14, 14′).

19. Device in accordance with one of claims 1 to 18, characterised in that the two supporting elements (14, 14′) are connected via a lengthwise-elastic bellows arranged between the two.

20. Device in accordance with claim 19, characterised in that the bellows encloses the connecting devices (18) at least externally, and in addition particularly internally.

21. Device in accordance with one of claims 1 to 20, characterised in that the connecting device (18) is lengthwise adjustable, hydraulically, pneumatically, mechanically or electrically.

22. Device in accordance with claim 21, characterised in that the connecting devices (18) includes a hydraulic unit, linear unit, spindle unit or linear motor.

23. Device in accordance with one of claims 1 to 22, characterised in that the two supporting elements (14, 14′) with at least three connecting devices (18) arranged between them are integrally mounted on the facing ends (16, 16′) of the two vehicle elements (12, 12′).

24. Device in accordance with claim 23, characterised in that at least one supporting element (14, 14′) is detachably interlinked with the associated facing ends (16, 16′) with one of the two vehicle elements (12, 12′).

25. Device in accordance with one of claims 1 to 24, characterised in that two supporting elements (14, 14′) with at least three connecting devices (18) arranged between them are detachably interlinked with the facing ends (16, 16′) of the two vehicle elements (12, 12′).

26. Device in accordance with claim 25, characterised in that the two supporting elements (14, 14′) of the facing ends (16, 16′) of the two vehicle elements (12, 12′) can be secured by friction and/or shape-interlocking connections providing precise positioning.

27. Device in accordance with claim 26, characterised in that the shape-interlocking connections are designed as swallow tail, key and keyway or similar connections.

28. Device in accordance with one of claims 25 to 27, characterised in that the two supporting elements (14, 14′) with the at least three connecting devices (18) can be mounted vertically from above or horizontally from the side on the ends of the two vehicle elements (12, 12′).

29. Device in accordance with one of claims 26 to 28, characterised in that the two supporting elements (14, 14′) with the at least three connecting devices (18) arranged in between are secured against automatic detachment after insertion in the shape-interlocking connection by bolts (54, 54′), pins, screws, detent, snap or similar devices.

30. Device in accordance with one of claims 1 to 29, characterised in that the connecting-devices (18) are connected with at least one control device for their open-circuit or closed-circuit control.

31. Device in accordance with claim 30, characterised in that the connecting devices (18) are adjustable by at least one control device either individually or all tuned together.

32. Device in accordance with claim 30 or 31, characterised in that the at least one control device is provided with a transmitting/receiving device for control by means of radio and/or GPS or GSM standard and/or infrared.

33. Use of an inventive device (10) in accordance with one of the preceding claims for the detachable interlinking of two vehicle elements (12, 12′) of linked vehicles arranged in tandem, on land, on water, in the air and in space.
